(19) United States
(12) Patent Application Publication
(10) Pub. No.: US 2025/0266751 A1
(43) Pub. Date: Aug. 21, 2025

(54) CURRENT SHARING TOPOLOGY FOR PARALLEL POWER SUPPLIES

(71) Applicant: Analog Devices, Inc., Wilmington, MA (US)

(72) Inventor: Adrien Gambino, Chandler, AZ (US)

(21) Appl. No.: 19/057,538

(22) Filed: Feb. 19, 2025

Related U.S. Application Data
(60) Provisional application No. 63/555,749, filed on Feb. 20, 2024.

(51) Int. Cl. H02M 1/00; B60R 16/033

(52) U.S. Cl. CPC H02M 1/0067; B60R 16/033; H02M 1/0009; H02M 1/0087

(57) ABSTRACT

The present subject matter relates to an electronic system including multiple power supply circuits connected in parallel. A first power supply circuit includes a current sensing circuit configured to measure current to the first power supply circuit and total current drawn by the multiple power supply circuits. A second power supply circuit is connected in parallel to the first power supply circuit and includes a current sensing circuit configured to measure current to the second power supply circuit and the total current drawn by the multiple power supply circuits. Each of the first and second power supply circuits are configured to change operation of the power supply circuit to reduce current drawn by the power supply circuit when either the current to the power supply circuit or the total current drawn by the multiple power supply circuits exceeds a specified current limit level.

### CLAIM OF PRIORITY

This application claims priority to U.S. Provisional Application Ser. No. 63/555,749, filed Feb. 20, 2024, which is incorporated by reference herein in its entirety.

### FIELD OF THE DISCLOSURE

This document pertains generally, but not by way of limitation, to electronic circuits, and more particularly, to power supplies in vehicles.

### BACKGROUND

Electronic systems in vehicles such as automobiles can include parallel power supplies that may be used to provide power for things such as the automobiles infotainment system. These power supplies may derive their electrical power from the automotive battery. Discharged car batteries or electrical transients due to engine cranking and starting/stopping can cause the battery voltage to drop (e.g., to as low as 4V) causing very high input currents to be drawn while the vehicle's infotainment systems are operating. Such high currents could cause a fuse to trip or other electrical issues. One example of a higher power infotainment system use is passenger device charging using a universal serial bus (USB) power port. With output powers up to 100 watts (100 W) per port, input current may exceed tens of amps during transients.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a circuit diagram of an example of power supply circuits connected in parallel.

FIG. 2 is a circuit diagram of another example of power supply circuits connected in parallel.

FIG. 3 is a flow diagram of an example of a method of operating multiple power supplies of an electronic system.

### DETAILED DESCRIPTION

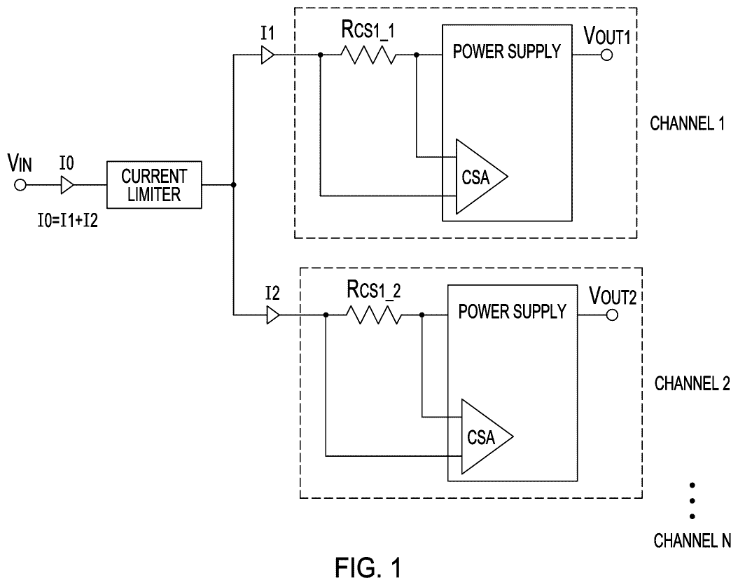

An electronic system may include parallel power supplies. FIG. 1 is a circuit diagram of portions of an example of an electronic system that includes two power supplies connected in parallel. The power supplies may provide charging capability (e.g., as a USB power delivery (USB-PD) system). When input current must be limited in applications using parallel power supplies, a current limiter circuit may be used that will reduce the input voltage in an over-current condition.

For example, in automotive applications, power supply modules may experience sudden drops of input voltage (e.g., due to engine starting). The sudden drop in input voltage can cause input current to the power supply circuits to rise beyond the fuse rating. However, the addition of a current limit circuit increases cost and complexity of the system, which may not be desirable. In another approach, the output power could be reduced before or during the transients to reduce the input current demand. However, reducing power under an explicit power delivery contract can take several tens of milliseconds before the USB Sink device connected to the power supply reduces its load. New source capabilities must be sent, and a request message must be received by the source before transitioning to the new voltage and/or current. Moreover, some sinks may not reduce their current to the new contracted value, causing the voltage bus to drop and charging to stop.

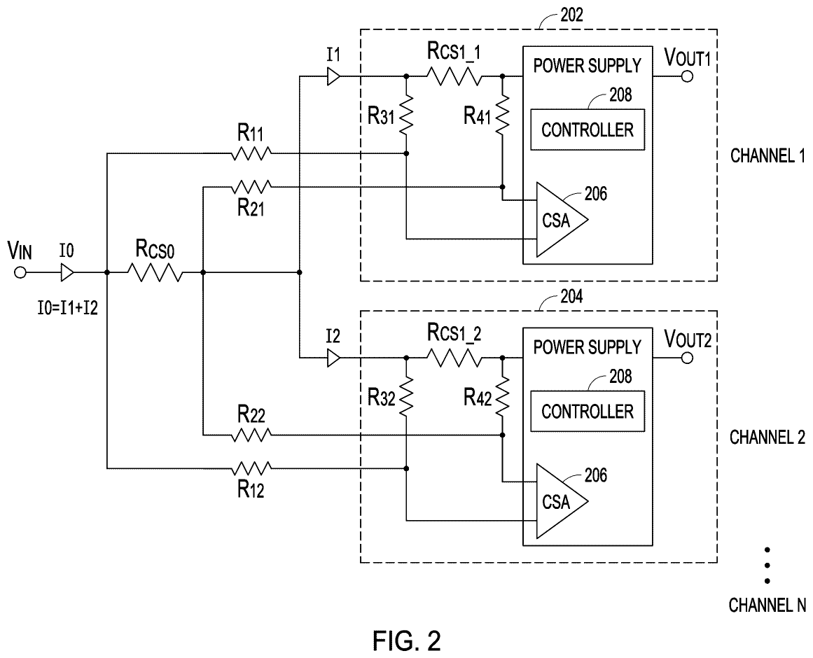

FIG. 2 is a circuit diagram of portions of another example of an electronic system having power supply circuits (202, 204) connected in parallel to a common energy source (V_{IN}), such as an automotive electrical system for example. The system in FIG. 2 does not include a current limiter circuit. The example of FIG. 2 shows two power supply circuits for two charging channels, but the system may include N channels, where N is an integer greater than two. The system may be included in a USB-PD delivery system and the output nodes (Vout1, Vout2, . . . VoutN) may be connected to USB charging ports.

The power supply circuits may include direct current to direct current (DC-to-DC) switching converter circuits (e.g., a buck-boost DC-to-DC switching converter circuit) or alternating current to direct current (AC-to-DC) switching converter circuits. Each power supply circuit includes a controller 208 that controls switching of the power supply circuit. Each power supply circuits include a current sensing circuit that includes a high-side high-bandwidth current sensing amplifier (CSA 206) for cycle-by-cycle peak input current limiting. The high-side input current sensing is done using a precision 1% sense resistor labeled Rcsi_1. A single input resistor is used to sense the current input to each channel. For a dual channel (N=2) current is sensed using sense resistor labeled Rcsi_₂. Without more current sensing, the total input current will be the sum of each channel input current. For instance, if each channel is designed to enter input current limit at 6 Amps (6 A), then when both channels enter current limit, the total module input current will be 12 A. The system of FIG. 2 includes a third current sense resistor Rc₅₀ as well as bridge resistors (R11, R21, R31, R41, R12, R22, R32, R42) to sense the total module current and shift the sensed voltage on each channel, accordingly, allowing a much lower total input current. The third resistor Rc₅₀ is connected in series to the other current sense resistors. The CSA 206 of each of the power supply circuits is connected to the third resistor Rc₅₀ to sense current in the third resistor Rc₅₀. The controller 208 of each of the power supply circuits is configured to change operation to reduce current drawn by its respective power supply circuit (e.g., by reducing a switching duty cycle) when either the input current to the power supply circuit or the total current drawn by the multiple power supply circuits exceeds a specified current limit level. For example, if each channel is designed to limit input current limit to 6 A, the total module input current will be limited to 6 A and not 12 A as when the total input current from the common input voltage node V_{IN} is monitored. The circuit of FIG. 2 allows different current to be shifted to each of the channels with the total current limited to the specified total current limit (e.g., 6 A). The approach in FIG. 2 provides a simple and effective method to limit the automotive module input current under battery transients while providing full USB-PD power under normal conditions.

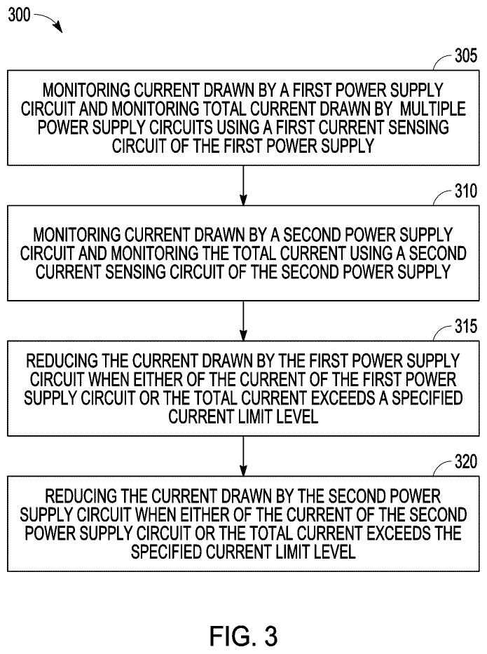

For completeness, FIG. 3 is a flow diagram of an example of a method 300 of operating multiple power supply circuits of an electronic system, such as the power supply circuits of FIG. 2. The power supply circuits are connected in parallel with each other, and are connected to a common input node that sources energy for the power supply circuits. The energy source may be a vehicle battery system. At block 305, current drawn by a first power supply circuit of multiple power supply circuits and the total current drawn by the multiple power supply circuits are both monitored using a first current sensing circuit of the first power supply circuit. At block 310, current drawn by a second power supply circuit of and the total current drawn by the multiple power supply circuits are both monitored using a second current sensing circuit of the second power supply circuit.

At block 315, the current drawn by the first power supply circuit is reduced when either of the current of the first power supply circuit or the total current exceeds a specified current limit level. At block 320, the current drawn by the second power supply circuit is reduced when either of the current of the second power supply circuit or the total current exceeds the specified current limit level.

The techniques described herein can provide current protection to an infotainment system of a vehicle with low cost and high efficiency.

### ADDITIONAL DESCRIPTION AND EXAMPLES

A first Example (Example 1) includes subject matter such as an electronic system, comprising multiple power supply circuits connected in parallel including a first power supply circuit and at least a second power supply circuit connected in parallel to the first power supply circuit. The first power supply circuit includes a first current sensing circuit configured to measure current to the first power supply circuit and total current drawn by the multiple power supply circuits. The second power supply circuit includes a second current sensing circuit configured to measure current to the second power supply circuit and the total current drawn by the multiple power supply circuits. Each of the first and second power supply circuits are configured to change operation of the power supply circuit to reduce current drawn by the power supply circuit when either the current to the power supply circuit or the total current drawn by the multiple power supply circuits exceeds a specified current limit level.

In Example 2, the subject matter of Example 1 optionally includes the first and second power supply circuits configured to shift the total current drawn between the first and second power supply circuits without the total current drawn by the multiple power supply circuits exceeding the specified current limit level.

In Example 3, the subject matter of Example 2 optionally includes a common energy source and first, second, and third current sense resistors. The first and third current sense resistors are connected in series from the common energy source to an input of the first power supply circuit and connected together at a first circuit node, and the second current sense resistor is connected from the first circuit node to an input of the second power supply circuit. The first current sensing circuit includes a current sense amplifier that senses current in both the first and third current sense resistors and the second current sensing circuit includes another current sense amplifier that senses current in both the second and third current sense resistors.

In Example 4, the subject matter of Example 3 optionally includes the first current sense resistor included in a first channel between the common energy source and the first power supply circuit, and the second sense resistor included in a second channel between the common energy source and the second power supply circuit.

Bridge resistors are connected to the first, second, and third current sense resistors to shift a voltage sensed by the first and second current sensing circuits.

In Example 5, the subject matter of one any combination of Examples 1-4 optionally includes the first and second power supply circuits being switching power supply circuits and each of the first and second power supply circuits are configured to change a duty cycle of switching of the power supply circuit to reduce current drawn by the power supply circuit.

In Example 6, the subject matter of Example 5 optionally includes the first and second power supply circuits including switching direct current to direct current (DC-to-DC) converter circuits.

In Example 7, the subject matter of Example 5 optionally includes the first and second power supply circuits including switching alternating current to direct current (AC-to-DC) converter circuits.

In Example 8, the subject matter of one or any combination of Examples 1-7 optionally includes multiple universal serial bus (USB) charging ports including at least a first USB charging port and a second USB charging port. The output of the first power supply circuit is connected to the first USB charging port and the output of the second power supply circuit is connected to the second USB charging port.

Example 9 include subject matter (such as a method of operating multiple power supply circuits of an electronic system that includes multiple power supply circuits connected in parallel) or can optionally be combined with one or any combination of Examples 1-8 to include such subject matter, comprising monitoring current drawn by a first power supply circuit of the multiple power supply circuits and monitoring total current drawn by the multiple power supply circuits using a first current sensing circuit of the first power supply circuit, monitoring current drawn by a second power supply circuit of the multiple power supply circuits and monitoring the total current drawn by the multiple power supply circuits using a second current sensing circuit of the second power supply circuit, reducing the current drawn by the first power supply circuit when either of the current of the first power supply circuit or the total current exceeds a specified current limit level, and reducing the current drawn by the second power supply circuit when either of the current of the second power supply circuit or the total current exceeds the specified current limit level.

In Example 10, the subject matter of Example 9 optionally includes changing operation of the first and second power supply circuits to shift proportions of the total current drawn by the multiple power supply circuits between the first and second power supply circuits without the total current drawn by the multiple power supply circuits exceeding the specified current limit level.

In Example 11, the subject matter of one or both of Examples 9 and 10 optionally includes providing energy to the multiple power supply circuits using a common energy source; and monitoring current by the first current sensing circuit sensing total current from the common energy source and sensing first input current input to the first power supply circuit, and wherein the first power supply circuit compares each of the sensed total current from the common energy source and the sensed first input current to the specified current limit level; and the second current sensing circuit sensing total current from the common energy source and sensing second input current input to the second power supply circuit, and wherein the second power supply circuit compares each of the sensed total current from the common energy source and the sensed second input current to the specified current limit level.

In Example 12, the subject matter of one or any combination of Examples 9-11 optionally includes operating switching power supply circuits as the first and second power supply circuits; changing a duty cycle of switching of the first power supply circuit when either of the current of the first power supply circuit or the total current exceeds the specified current limit level; and changing a duty cycle of switching of the second power supply circuit when either of the current of the second power supply circuit or the total current exceeds the specified current limit level.

In Example 13, the subject matter of Example 12 optionally includes operating switching DC-to-DC converter circuits of the first and second power supply circuits.

In Example 14, the subject matter of Example 12 optionally includes operating switching AC-to-DC converter circuits of the first and second power supply circuits.

In Example 15, the subject matter of one or any combination of Examples 9-14 optionally includes providing power from the first power supply circuit to a first universal serial bus (USB) charging port, and providing power from the second power supply circuit to a second USB charging port.

Example 16 includes subject matter (such as a USB power delivery (USB-PD) system) or can optionally be combined with one or any combination of Examples 1-15 to include such subject matter, comprising an energy source, a first power supply circuit including an input connected to the energy source and an output connected to a first USB charging port, and a second power supply circuit including an input connected to the energy source and an output connected to a second USB charging port. The first power supply circuit includes a first current sensing circuit configured to measure current to the first power supply circuit and total current drawn by both the first and second power supply circuits, and the second power supply circuit includes a second current sensing circuit configured to measure current to the second power supply circuit and the total current drawn by both the first and second power supply circuits. Each of the first and second power supply circuits are configured to change operation of the respective power supply circuit to reduce current drawn by the respective power supply circuit when either the current to the power supply circuit or the total current drawn by both the power supply circuits exceeds a specified current limit level.

In Example 17, the subject matter of Example 16 optionally includes each of the first and second power supply circuits are configured to change operation by changing current drawn from the energy source between the first and second power supply circuits without the total current drawn from the energy source exceeding the specified current limit level.

In Example 18, the subject matter of one or both of Examples 16 and 17 optionally includes first, second, and third current sense resistors. The first and third current sense resistors are connected in series from the energy source to an input of the first power supply circuit and connected together at a first circuit node, and the second current sense resistor is connected from the first circuit node to an input of the second power supply circuit. The first current sensing circuit includes a current sense amplifier that senses current in both the first and third current sense resistors and the second current sensing circuit includes another current sense amplifier that senses current in both the second and third current sense resistors.

In Example 19, the subject matter of one or any combination of Examples 16-18 optionally includes the first power supply circuit being a buck-boost direct current to direct current (DC-to-DC) switching power supply circuit and including a first controller, and the second power supply circuit being a buck-boost DC-to-DC switching power supply circuit and including a second controller. Each of the first and second controllers is configured to change a duty cycle of switching of its respective switching power supply circuit to reduce current drawn by the switching power supply circuit.

In Example 20, the subject matter of one or any combination of Examples 16-19 optionally includes the energy source being a vehicle electrical system.

These Examples can be combined in any permutation or combination. The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in a claim are still deemed to fall within the scope of that claim. Moreover, in the following aspects, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following aspects are hereby incorporated into the Detailed Description as examples or embodiments, with each aspect standing on its own as a separate embodiment, and it is contemplated that such embodiments can be combined with each other in various combinations or permutations.

What is claimed is:

1. An electronic system, the system comprising:
multiple power supply circuits connected in parallel including a first power supply circuit and at least a second power supply circuit connected in parallel to the first power supply circuit;
wherein the first power supply circuit includes a first current sensing circuit configured to measure current to the first power supply circuit and total current drawn by the multiple power supply circuits;
wherein the second power supply circuit includes a second current sensing circuit configured to measure current to the second power supply circuit and the total current drawn by the multiple power supply circuits; and
wherein each of the first and second power supply circuits are configured to change operation of the power supply circuit to reduce current drawn by the power supply circuit when either the current to the power supply circuit or the total current drawn by the multiple power supply circuits exceeds a specified current limit level.

2. The system of claim 1, wherein the first and second power supply circuits are configured to shift the total current drawn between the first and second power supply circuits without the total current drawn by the multiple power supply circuits exceeding the specified current limit level.

3. The system of claim 1, including:
a common energy source;
first, second, and third current sense resistors, wherein the first and third current sense resistors are connected in series from the common energy source to an input of the first power supply circuit and connected together at a first circuit node, and the second current sense resistor is connected from the first circuit node to an input of the second power supply circuit; and
wherein the first current sensing circuit includes a current sense amplifier that senses current in both the first and third current sense resistors and the second current sensing circuit includes another current sense amplifier that senses current in both the second and third current sense resistors.

4. The system of claim 3,
wherein the first current sense resistor is included in a first channel between the common energy source and the first power supply circuit, and the second sense resistor is included in a second channel between the common energy source and the second power supply circuit; and
wherein system further includes bridge resistors connected to the first, second, and third current sense resistors to shift a voltage sensed by the first and second current sensing circuits.

5. The system of claim 1,
wherein the first and second power supply circuits are switching power supply circuits; and
wherein each of the first and second power supply circuits are configured to change a duty cycle of switching of the power supply circuit to reduce current drawn by the power supply circuit.

6. The system of claim 5, wherein the first and second power supply circuits include switching direct current to direct current (DC-to-DC) converter circuits.

7. The system of claim 5, wherein the first and second power supply circuits include switching alternating current to direct current (AC-to-DC) converter circuits.

8. The system of claim 1, including multiple universal serial bus (USB) charging port, including at least a first USB charging port and a second USB charging port;
wherein an output of the first power supply circuit is connected to the first USB charging port; and
wherein an output of the second power supply circuit is connected to the second USB charging port.

9. A method of operating multiple power supply circuits of an electronic system that includes multiple power supply circuits connected in parallel, the method comprising:
monitoring current drawn by a first power supply circuit of the multiple power supply circuits and monitoring total current drawn by the multiple power supply circuits using a first current sensing circuit of the first power supply circuit;
monitoring current drawn by a second power supply circuit of the multiple power supply circuits and monitoring the total current drawn by the multiple power supply circuits using a second current sensing circuit of the second power supply circuit;
reducing the current drawn by the first power supply circuit when either of the current of the first power supply circuit or the total current exceeds a specified current limit level; and
reducing the current drawn by the second power supply circuit when either of the current of the second power supply circuit or the total current exceeds the specified current limit level.

10. The method of claim 9, including changing operation of the first and second power supply circuits to shift proportions of the total current drawn by the multiple power supply circuits between the first and second power supply circuits without the total current drawn by the multiple power supply circuits exceeding the specified current limit level.

11. The method of claim 9, including:
providing energy to the multiple power supply circuits using a common energy source;
wherein the monitoring the current includes:
the first current sensing circuit sensing total current from the common energy source and sensing first input current input to the first power supply circuit, and wherein the first power supply circuit compares each of the sensed total current from the common energy source and the sensed first input current to the specified current limit level; and
the second current sensing circuit sensing total current from the common energy source and sensing second input current input to the second power supply circuit, and wherein the second power supply circuit compares each of the sensed total current from the common energy source and the sensed second input current to the specified current limit level.

12. The method of claim 9, including:
operating switching power supply circuits as the first and second power supply circuits;
wherein the reducing the current drawn by the first power supply circuit includes changing a duty cycle of switching of the first power supply circuit when either of the current of the first power supply circuit or the total current exceeds the specified current limit level; and
wherein the reducing the current drawn by the second power supply circuit includes changing a duty cycle of switching of the second power supply circuit when either of the current of the second power supply circuit or the total current exceeds the specified current limit level.

13. The method of claim 12, wherein the operating the switching power supply circuits includes operating switching direct current to direct current (DC-to-DC) converter circuits of the first and second power supply circuits.

14. The method of claim 12, wherein the operating the switching power supply circuits includes operating switching alternating current to direct current (AC-to-DC) converter circuits of the first and second power supply circuits.

15. The method of claim 9, including:
providing power from the first power supply circuit to a first universal serial bus (USB) charging port; and
providing power from the second power supply circuit to a second USB charging port.

16. A universal serial bus (USB) power delivery system, the system comprising:
an energy source;
a first power supply circuit including an input connected to the energy source and an output connected to a first USB charging port; and
a second power supply circuit including an input connected to the energy source and an output connected to a second USB charging port;
wherein the first power supply circuit includes a first current sensing circuit configured to measure current to the first power supply circuit and total current drawn by both the first and second power supply circuits;
wherein the second power supply circuit includes a second current sensing circuit configured to measure current to the second power supply circuit and the total current drawn by both the first and second power supply circuits; and
wherein each of the first and second power supply circuits are configured to change operation of the respective power supply circuit to reduce current drawn by the respective power supply circuit when either the current to the power supply circuit or the total current drawn by both the power supply circuits exceeds a specified current limit level.

17. The system of claim 16, wherein each of the first and second power supply circuits are configured to change operation by changing current drawn from the energy source between the first and second power supply circuits without the total current drawn from the energy source exceeding the specified current limit level.

18. The system of claim 16, including:
first, second, and third current sense resistors, wherein the first and third current sense resistors are connected in series from the energy source to an input of the first power supply circuit and connected together at a first circuit node, and the second current sense resistor is connected from the first circuit node to an input of the second power supply circuit; and
wherein the first current sensing circuit includes a current sense amplifier that senses current in both the first and third current sense resistors and the second current sensing circuit includes another current sense amplifier that senses current in both the second and third current sense resistors.

19. The system of claim 16,
wherein the first power supply circuit is a buck-boost direct current to direct current (DC-to-DC) switching power supply circuit and includes a first controller, and the second power supply circuit is a buck-boost DC-to-DC switching power supply circuit and includes a second controller; and
wherein each of the first and second controllers is configured to change a duty cycle of switching of its respective switching power supply circuit to reduce current drawn by the switching power supply circuit.

20. The system of claim 16, wherein the energy source is a vehicle electrical system.
